(19) United States
(12) Patent Application Publication
(10) Pub. No.: US 2010/0006349 A1
(43) Pub. Date: Jan. 14, 2010

(54) SENSOR DEVICE AND METHOD OF OPERATING THE SAME

(75) Inventors: Jei-Hyuk Lee, Yongin-si (KR); Bang-Won Lee, Yongin-si (KR); Young-Ho Shin, Yongin-si (KR); Jae-Surk Hong, Yongin-si (KR)

Correspondence Address: CANTOR COLBURN, LLP, 20 Church Street, 22nd Floor, Hartford, CT, 06103, US

(73) Assignee: ATLab Inc., Yongin-si (KR)

(21) Appl. No.: 12/517,741

(22) PCT Filed: Sep. 11, 2007
(86) PCT No.: PCT/KR07/04394

§ 371 Date: Jun. 4, 2009

(30) Foreign Application Priority Data
Dec. 7, 2006 (KR) 10-2006-0123952

(51) Int. Cl. G06F 3/041

(52) U.S. Cl. 178/18.03

(57) ABSTRACT

Provided are a sensor device and a method of operating the same. The sensor device includes a plurality of semiconductor devices connected in series. When a semiconductor device does not sense a state of contact with an object and receives first sensing data from a preceding semiconductor device, the semiconductor device outputs the first sensing data to a succeeding semiconductor device. When the semiconductor device senses the state of contact with the object and receives the first sensing data from the preceding semiconductor device, the semiconductor device generates second sensing data and outputs the first and second sensing data to the succeeding semiconductor device. When the semiconductor device senses the state of contact with the object and does not receive the first sensing data from the preceding semiconductor device, the semiconductor device generates the second sensing data and outputs the second sensing data to the succeeding semiconductor device. The method includes the steps of: generating, by at least one semiconductor device for generating a sense signal, identification (ID) information, storing and outputting the ID information to the succeeding semiconductor device after a supply voltage is initially applied to the semiconductor device; outputting first sensing data to the succeeding semiconductor device when a state of contact with an object is not sensed and the first sensing data is received from a preceding semiconductor device; generating second sensing data when the state of contact with the object is sensed, and outputting the first sensing data and the second sensing data when the first sensing data is received from the preceding semiconductor device; and outputting the second sensing data when the first sensing data is not received from the preceding semiconductor device.

### TECHNICAL FIELD

The present invention relates to a sensor device and a method of operating the same and, more particularly, to a sensor device and a method of operating the same, which can reduce the size of data transmitted and received between two or more semiconductor devices.

### BACKGROUND ART

A sensor system of an electronic device includes a plurality of input channels (i.e., a buttons or touch pads) and touch sense signal generators. Each of touch sense signal generators is connected to at least one input channel to generate a touch sense signal. Thus, the sensor system transmits the touch sense signal to a host computer to recognize externally input touch information. In this case, the touch sense signal generators are connected in a daisy-chain manner, which is a kind of serial connection method, to effectively transmit and receive touch signals and other information.

FIG. 1 is a block diagram showing a conventional communication method used to connect touch sense signal generators.

Sense signal generators 100-1 to 100-N include input/output (I/O) terminals 1-2 to N-2 and 1-3 to N-3, terminals 1-1 to N-1 connected to touch pads 110-1 to 110-N, terminals 1-4 to N-4 connected to a power supply voltage VDD, and terminals 1-5 to N-5 connected to a ground voltage VSS.

The touch pads 110-1 to 110-N are connected to the touch sense signal generators 100-1 to 100-N, respectively. When an object, i.e., a conductive resistor (e.g., a human finger), is brought into contact with each of the touch pads 110-1 to 110-N, each of the touch pads 110-1 to 110-N is used to generate a touch signal in response to a change in electrical state and to output the touch signal to the corresponding one of the touch sense signal generators 100-1 to 100-N.

FIG. 1 illustrates a method of serially connecting adjacent touch sense signal generators 100-1 to 100-N (here, N is a natural number). In this case, a host computer 120 receives a touch sense signal from N-th touch sense signal generator 100-N in order to confirm the touch signal generated from the N number of touch sense signal generators. The touch sense signal includes not only touch identification information of the touch sense signal generator detecting a state of contact with an object but also the touch identification information of the touch sense signal generator detecting no state of contact with the object.

The touch sense signal generator adds the touch identification signal indicating whether a corresponding touch pad contacts an external object to the touch identification signal received from a preceding touch sense signal generator to transmit to a succeeding touch sense signal generator. N-th touch sense signal generator 100-N transmits accumulated touch identification information of a 1^{st} touch sense signal generator through (N−1)-th touch sense signal generators, a touch identification information generated by the N-th touch sense signal generator 100-N, a start bit, and a end bit to the host computer 120.

For example, supposing that the first touch pad 110-1 included in the first touch sense signal generator 100-1 contacts an external object, the first touch sense signal generator 100-1 outputs total 3-bit data including start/end bits and touch identification information bit and signal start/end bits, to the second touch sense signal generator 100-2. The second touch sense signal generator 100-2 receives the 3-bit data and adds the 3-bit data into the touch identification information (1-bit) including a touch information indicating non-contact of the second touch pad 110-2 with the object to transmit 4-bit data to the third touch sense signal generator 100-3. Thus, when five touch sense signal generators 100-1 to 100-5 are connected in series, the fifth touch sense signal generator 100-5 transmits 7-bit data to the host computer 120. However, in this case, the size of data transmitting from the first touch sense signal generator 100-1 to the host computer 120 is 25-bit. In other words, 25-bit data is required to measure all 5 touch pads.

Considering this regularity, when N touch sense signal generators 100-1 to 100-N are connected in series, the size of data transmitting from the first touch sense signal generator 100-1 to the host computer 120 is 2N+(N(N+1)/2) bits. Thus, as the number N of the touch sense signal generators increases, the size of data transmitted to the host computer 30 increases by N². Because constant data is always transmitted irrespective of a state of contact or non-contact of each touch sense signal generator with an object, the size of data transmitted and received between one or more sense signal generators greatly increases.

As described above, a conventional sensor device has become problematic in that all touch sense signal generators 100-1 to 100-N should transmit position information to the host computer 120 irrespective of whether or not each of the touch sense signal generators 100-1 to 100-N generates a touch signal. Therefore, developing a semiconductor device and a method of operating the same to solve the transmission of unnecessary data is required.

### DISCLOSURE

### Technical Problem

The present invention is directed to a sensor device that can reduce the size of data that is transmitted and received between two or more semiconductor devices in response to an external input signal.

The present invention is also directed to a method of operating a sensor device that can reduce the size of data that is transmitted and received between two or more semiconductor devices in response to an external input signal.

### Technical Solution

One aspect of the present invention provides a sensor device including a plurality of semiconductor devices connected in series. When a semiconductor device does not sense a state of contact with an object and receives a first sensing data from a preceding semiconductor device, the semiconductor device outputs the first sensing data to a succeeding semiconductor device. When the semiconductor device senses the state of contact with the object and receives the first sensing data from the preceding semiconductor device, the semiconductor device generates a second sensing data and outputs the first sensing data and the second sensing data to the succeeding semiconductor device. Also, when the semiconductor device senses the state of contact with the object and does not receive the first sensing data from the preceding semiconductor device, the semiconductor device generates the second sensing data and outputs the second sensing data to the succeeding semiconductor device.

The sensor device may sense a touch or a pressure applied to the semiconductor device. Also, the semiconductor devices may be connected in a daisy-chain manner.

After a supply voltage is initially applied to the semiconductor device, the semiconductor device may generate and store identification (ID) information and output the ID information to the succeeding semiconductor device. The semiconductor device may output internally stored a third data to the succeeding semiconductor device in response to a control signal output from the preceding semiconductor device.

The first sensing data or the second sensing data may be a sensing information protocol including a sense signal.

The sensing information protocol may include: a start bit indicating the start of the sensing information protocol; the ID information; the sense signal of at least one bit; and an end bit indicating the end of the sensing information protocol.

The third data may include: an identification information protocol including a start bit indicating a start of the third data; the ID information; and an end bit indicating an end of the third data. Alternatively, the third data may include: a device setting information protocol including a start bit indicating the start of the third data; the ID information; at least 1-bit apparatus control information; and an end bit indicating the end of the third data.

The device setting information protocol may include information on the sensitivity of a touch pad included in the semiconductor device.

The semiconductor device may include: at least one input/output (I/O) terminal; at least one touch pad; an I/O controller for enabling the semiconductor device to communicate with an adjacent semiconductor device; a controller for controlling the I/O controller in response to a touch; and a switch for turning on/off the I/O controller.

The controller may include: a reference signal generation unit for generating a clock signal as a reference signal; a first signal generation unit for receiving the reference signal and always delaying the reference signal by a first time irrespective of a state of contact of the semiconductor device with the object to generate a first signal; a second signal generation unit for receiving the reference signal, the second signal generation unit not delaying the reference signal when the semiconductor device does not sense the state of contact with the object, and delaying the reference signal by a second time longer than the first time to generate a second signal when the semiconductor device senses the state of contact with the object; and a sense signal generation unit for sampling and latching the second signal in synchronization with the first signal to generate a sense signal.

The I/O controller may include: an I/O transceiving unit for communicating with the semiconductor device; an input information analysis unit for analyzing the first sensing data and the third data applied to the I/O transceiving unit to output the analyzed data to the controller; and an output information generation unit for generating the second sensing data in response to data output from the controller to output the second sensing data to the I/O transceiving unit.

Another aspect of the present invention provides a method of operating a sensor device, the method including the steps of: generating, by at least one semiconductor device for generating a sense signal, identification (ID) information, storing and outputting the ID information to the succeeding semiconductor device after a supply voltage is initially applied to the semiconductor device; outputting a first sensing data to the succeeding semiconductor device when a state of contact with an object is not sensed and the first sensing data is received from a preceding semiconductor device; generating a second sensing data when the state of contact with the object is sensed, and outputting the first sensing data and the second sensing data to the succeeding semiconductor device when the first sensing data is received from the preceding semiconductor device; and outputting the second sensing data to the succeeding semiconductor device when the first sensing data is not received from the preceding semiconductor device.

In this method, a touch or a pressure applied to the semiconductor device may be sensed and processed.

The step of generating, by at least one semiconductor device for generating a sense signal, identification (ID) information comprises the steps of: stopping the output of the sense signal after a supply voltage is initially applied to the semiconductor device; applying a predetermined voltage to the semiconductor device and comparing the predetermined voltage with an actually applied voltage to recognize a different semiconductor device as the semiconductor device at a start position; outputting the ID information generated by the semiconductor device at the start position to the succeeding semiconductor device; and outputting, by an N-th semiconductor device, only ID information generated by the semiconductor device at the start position when ID information is received from an (N−1)-th semiconductor device, where N is a natural number.

The step of outputting the ID information may include the step of combining the generated ID information with the ID information generated by at least one preceding semiconductor device and outputting the resultant ID information to the succeeding semiconductor device after a supply power is initially applied to the semiconductor device.

The method may further include the steps of: outputting a preparation signal from the preceding semiconductor device to the succeeding semiconductor device; and generating, by the at least one semiconductor device, the sense signal in response to the preparation signal when the state of contact with the object is sensed.

The method may further include the step of outputting, by the semiconductor device, internally stored a first data including sensitivity data in response to a control signal from the preceding semiconductor device.

### ADVANTAGEOUS EFFECTS

As a consequence, a sensor device according to the present invention enables serial communication of data between semiconductor devices so that the number of connection lines can be lessened and the minimum data size required for the communication of data between the semiconductor devices can be reduced.

### DESCRIPTION OF DRAWINGS

FIG. 1 is a block diagram showing a conventional communication method used to connect touch sense signal generators.

FIG. 2 is a diagram showing the construction of a semiconductor device included in a sensor device according to an exemplary embodiment of the present invention.

FIG. 3 is a diagram showing a method of communicating data between sensor devices shown in FIG. 2 according to an exemplary embodiment of the present invention.

FIG. 4 is a block diagram showing a method of communicating data between semiconductor devices according to an exemplary embodiment of the present invention.

FIG. 5 is a diagram showing an identification information protocol for the communication of data between semiconductor devices according to an exemplary embodiment of the present invention.

FIG. 6 is a diagram showing an apparatus control information protocol for the communication of data between semiconductor devices according to an exemplary embodiment of the present invention.

FIG. 7 is a diagram showing a touch information protocol for the communication of data between semiconductor devices according to an exemplary embodiment of the present invention.

FIG. 8 is a diagram showing a method of controlling the sensitivity of a touch pad of a semiconductor device according to an exemplary embodiment of the present invention.

FIG. 9 is a flowchart showing a method of providing identification information of a semiconductor device according to an exemplary embodiment of the present invention.

### MODES OF THE INVENTION

A sensor device and a method of operating the same according to the present invention will now be described more fully hereinafter with reference to the accompanying drawings, in which exemplary embodiments of the invention are shown.

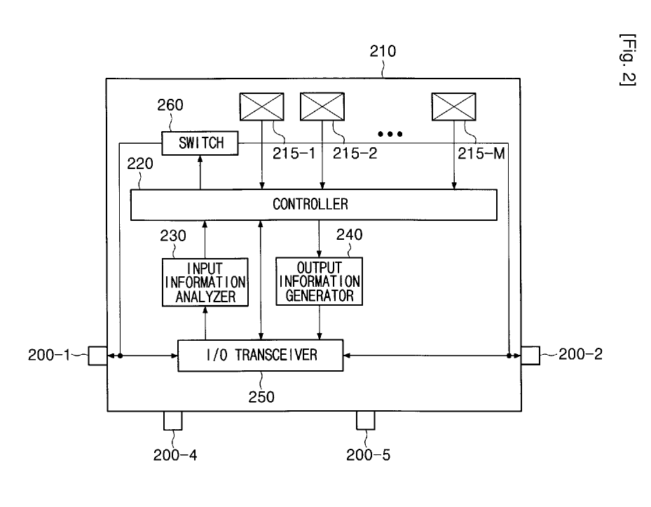

FIG. 2 is a diagram showing the construction of a semiconductor device included in a sensor device according to an exemplary embodiment of the present invention.

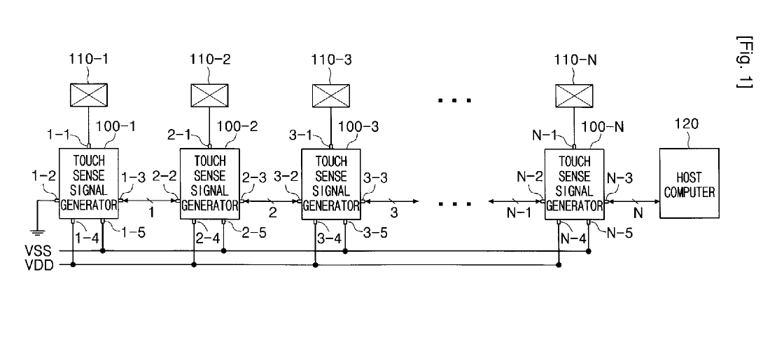

A semiconductor device 210 according to the present invention includes input/output (I/O) terminals 200-1 and 200-2, a power supply voltage terminal 200-4 connected to a power supply voltage VDD, and a ground voltage terminal 200-5 connected to a ground voltage VSS, which are external data I/O terminals, as in FIG. 1. The semiconductor device 210 includes a touch pad 215-1 to 215-M, a controller 220, an input information analyzer 230, an output information generator 240, an I/O transceiver 250, and a switch 260. An I/O controller communicating with an external semiconductor device includes the input information analyzer 230, the output information generator 240, and the I/O transceiver 250.

Functions of the respective blocks shown in FIG. 2 will now be described.

The controller 220 generates including an identification (ID) information of the semiconductor device 210 and an apparatus control information including setting information (e.g., the sensitivity of the touch pads 215-1 to 215-M), and a touch sense signal by sensing a state of contact of the touch pads 215-1 to 215-M included in the semiconductor device 210 to store the generated information and touch sense signal in an additional internal storage area (not shown).

After a supply voltage is initially applied to the semiconductor device 210, the switch 260 is set to a turn-off state not to connect the I/O terminals 200-1 and 200-2. Subsequently, the switch 260 is turned on to receive and output externally input data or to transmit output data to the semiconductor devices connected in series. Here, it is natural that the switch is also implemented with logic gates.

The I/O transceiver 250 receives touch information from the first I/O terminal 200-1 and second I/O terminal 200-2 and transmits the touch information to the controller 220 and the input information analyzer 230. The input information analyzer 230 analyzes the touch information and outputs the touch information to the controller 220, and the controller 220 outputs related information to communication with an external semiconductor device. Thereafter, the output information generator 240 generates data having a predetermined protocol and outputs the data to the I/O transceiver 250.

Thereafter, the semiconductor device 210 remains in a stand-by state until a preparation signal is applied from a host computer. In the current embodiment, although the touch pad 215 is included in the semiconductor device 210, it is clear that the touch pad 215 may be disposed outside the semiconductor device 210.

FIG. 3 illustrates an embodiment of a sense signal generator of the controller in the semiconductor device shown in FIG. 2. The sense signal generator 340 includes a reference signal generation unit 320, first and second signal generation units 325 and 330, and a sense signal generation unit 335.

Operation of the semiconductor device shown in FIG. 3 will now be described.

The first signal generation unit 325 comprises the top metal layer 315 which is brought into contact with an object in a die. When the object is not brought into contact with the top metal layer 315, the first signal generation unit 325 does not delay a reference signal ref_sig. When the object is brought into contact with top metal layer 325, the first signal generation unit 325 delays the reference signal ref_sig by a second time longer than a first time and generates a second signal sig2.

The sense signal generation unit 335 samples and latches the second signal sig2 in synchronization with a first signal sig1 and outputs a sense signal con_sig.

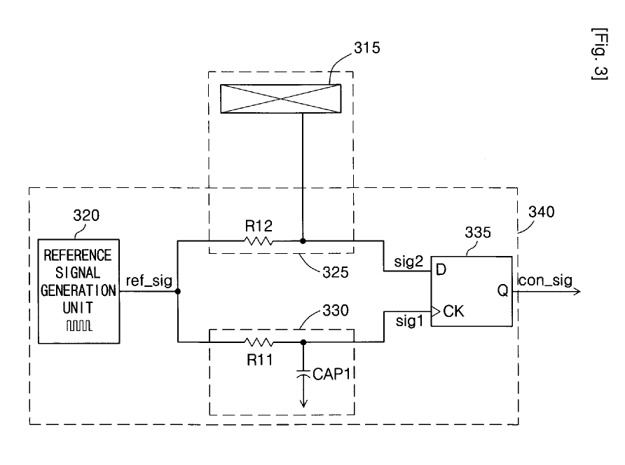

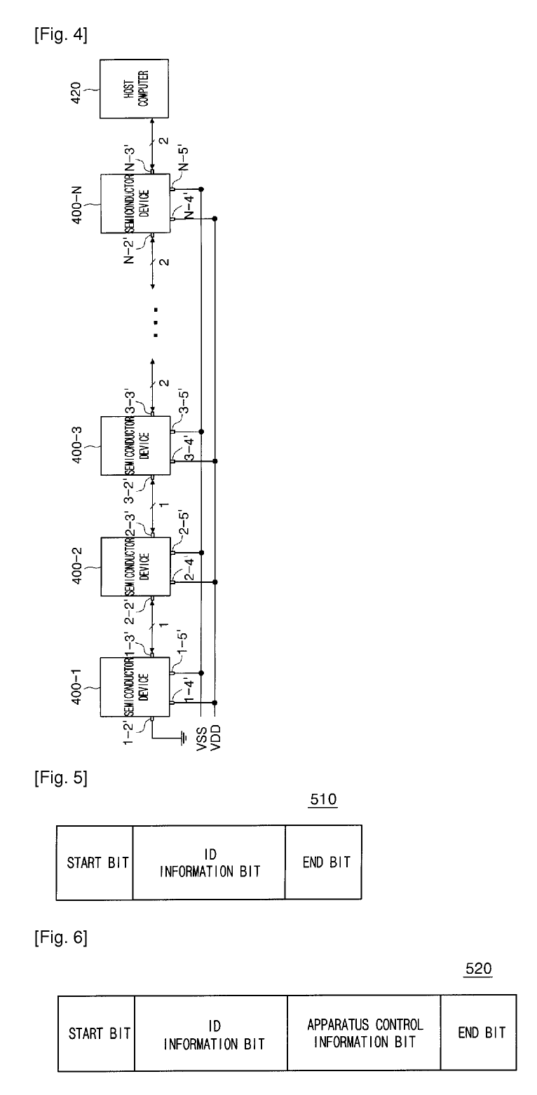

FIG. 4 is a block diagram showing a method of communicating data between semiconductor devices according to an exemplary embodiment of the present invention. Since function and operation of each of the semiconductor devices shown in FIG. 4 are the same as those of the semiconductor device shown in FIG. 2, the method of communicating data between the semiconductor devices will now be described with reference to FIGS. 2 and 4. However, a description of the same components as in FIG. 1 will be omitted.

Referring to FIG. 4, an N number of semiconductor devices 400-1 to 400-N (here, N is a natural number equal to or greater than 2) are connected in a daisy-chain manner, which is a serial connection method. Specifically, a first semiconductor device 400-1 is disposed adjacent to a second semiconductor device 400-2, and an (N−1)-th semiconductor device (not shown) is interposed between an (N−2)-th semiconductor device (not shown) and an N-th semiconductor device 400-N. Also, the N-th semiconductor device 400-N is interposed between the (N−1)-th semiconductor device and a host computer 420.

Each of the semiconductor devices 400-1 to 400-N communicates with an adjacent semiconductor device close to the host computer 420. In the conventional case, touch sense generators are serially connected and transmit accumulated ID information (information accumulating ID information from the semiconductor device 400-1 to the semiconductor device 400-N) to a host computer irrespective of a state of contact of each touch sense generator with an object. In comparison, according to the present invention, the touch information or ID information of a semiconductor device that actually generates a touch signal is output to an adjacent semiconductor device close to the host computer 420. Therefore, the present invention has furnished solutions to the transmission of unnecessary touch information resulting from the conventional serial connection method. As a result, after the application of an initial power supply voltage, ID information is automatically prepared and only the touch information of a semiconductor device generating a touch signal is transmitted.

The first semiconductor device 400-1 is locate at a start position, and sequentially changed ID information beginning with the start position are generated and assigned to the semiconductor devices 400-1 to 400-N. A method of generating ID information provided to discriminate the semiconductor devices 400-1 to 400-N includes a method of varying the frequencies of semiconductor devices by a predetermined degree from a start frequency (for example, a method of decreasing the frequencies of the semiconductor devices by halves), a method of adding a predetermined time delay to a reference signal output from a semiconductor device at a start position, and a method of gradually increasing a number indicating ID information from 1 to an natural number N.

The foregoing kinds of ID information may be selected according to the properties of each system if required. For example, a frequency divider may receive a predetermined frequency and output a frequency with a predetermined difference to the input frequency. Specifically, when the first semiconductor device 400-1 at a staring position generates a frequency of 100 KHz as the ID information and outputs the frequency to the second semiconductor device 400-2, a frequency divider (not shown) of the controller 220 in the second semiconductor device 400-2 may generate a frequency of 50 KHz, which is half the input frequency, as ID information of the second semiconductor device 400-2.

In another method, ID information may be generated to include a specific time delay in response to a reference signal having a predetermined frequency. The first semiconductor device 400-1 at a start position receives a reference signal through a counting circuit (not shown) included in the controller 220, delays the reference signal by a predetermined time, and generates the delayed reference signal. For example, when the first semiconductor device 400-1 generates a reference signal, which is repeated at a frequency of 10 Hz for 1 second, the second semiconductor device 400-2 receives the reference signal, additionally delays the reference signal by a predetermined time, and generates ID information.

In a third method, natural numbers, which are varied according to a predetermined rule on the basis of a predetermined natural number, are provided as ID information of the semiconductor devices 400-1 to 400-N. For instance, when the semiconductor devices 400-1 to 400-N are connected in a serial communication method, the first semiconductor device 400-1 at a start position generates the natural number “1” as ID information. The second semiconductor device 400-2 receives the natural number “1” and generates the natural number “2”, which is obtained by adding the natural number “1” to the input natural number “1”, as ID information. According to this rule, the N-th semiconductor device 400-N generates a natural number “N” as ID information. Thus, even if an arbitrary number of semiconductor devices are connected, it is possible to discriminate one semiconductor device from another semiconductor device.

The generated ID information is included in an ID information protocol shown in FIG. 5 and is generated in at least one time to the other semiconductor devices. Then, the switch is turned on and the semiconductor device remains in a stand-by state until it receives a preparation signal from the host computer 420.

In this case, the (N−1)-th semiconductor device may accumulate the ID information of the first semiconductor device 400-1 through the (N−2)-th semiconductor device (not shown) and output the accumulated ID information to the adjacent N-th semiconductor device 400-N. In this method, the host computer 420 can store the ID information of one or more serially connected semiconductor devices 400-1 to 400-N without undergoing an additional calculation process.

In another embodiment of the present invention, only the ID information of the N-th semiconductor device 400-N may be output to the host computer 420. Thus, the host computer 420 may confirm information required for communication (e.g., the number of the presently connected semiconductor devices 400-1 to 400-N) based on the ID information of the N-th semiconductor device 400-N with reference to a predetermined ID information generation method. Even if another kind of ID information is provided, since the ID information of the semiconductor devices 400-1 to 400-N has sequential values, the number of the presently connected semiconductor devices 400-1 to 400-N can be analogized out of the ID information of the N-th semiconductor device 400-N adjacent to the host computer 420. In the current embodiment, the size of data required for the communication of data between the semiconductor devices 400-1 to 400-N can be reduced compared with the previous embodiments. However, when storing ID information needed for accessing a specific semiconductor device, respective ID information should be extracted using an additional calculation process and stored.

As described above, the host computer 420, which is connected to the semiconductor device 400-N, confirms ID information and outputs a preparation signal to command the semiconductor device 400-N to start processing a touch signal. The N-th semiconductor device 400-N starts processing and outputting a touch sense signal in response to the preparation signal and outputs the corresponding preparation signal to the adjacent (N−1)-th semiconductor device.

A method of communicating data between the semiconductor devices 400-1 to 400-N when at least one of the semiconductor devices 400-1 to 400-N is in contact with an external object will now be described in detail.

For example, when only the second semiconductor device 400-2 shown in FIG. 4 is brought into contact with an object, a touch pad (not shown) included in the second semiconductor device 400-2 generates a touch signal to the controller 220 (refer to FIG. 2). The controller 220 confirms whether or not there is touch information externally input through I/O terminals 2-2′ and 2-3′. When there is no external touch information, the output information generator 240 (refer to FIG. 2) stores touch information including both the ID information of the semiconductor device 400-2 and the touch signal, and generates the touch information. Thereafter, the output information generator 240 outputs the touch information to the semiconductor device 400-3 close to the host computer 420 through the I/O transceiver 250 (refer to FIG. 2).

Upon receipt of the touch information, the input information analyzer 230 (refer to FIG. 2) of the semiconductor device 400-3 analyzes the touch information and outputs the ID information to the controller 220. The semiconductor device 400-3 checks whether or not the touch pad 215 connected to the controller 220 generates a touch signal. When the touch pad 215 does not generate the touch signal, the semiconductor device 400-3 outputs the received touch information without any added information to an adjacent semiconductor device (not shown) close to the host computer 420.

When receiving data from the preceding semiconductor device, the present semiconductor device accumulates the received data and newly generated data and outputs the accumulated data to the succeeding semiconductor device. In some cases, the actually transmitted data may be output as a type of a touch information protocol including touch information. Alternatively, previously stored apparatus information may be output as a type of an apparatus information protocol in response to a predetermined control signal received from the host computer 420. These data protocols will be described in detail later with reference to FIGS. 5 through 7.

As described above, since the touch information of the semiconductor device, which actually contacts the object, is transmitted to the host computer 420, the size of required data to be communicated between the semiconductor devices is reduced compared with a conventional serial communication method in which, when one of the semiconductor devices generates a touch signal, all semiconductor devices should accumulate position information and transmit the accumulated information to a host computer irrespective of whether or not each of the semiconductor devices generates a touch signal.

Considering this regularity, in case each of the start bit and the end bit and the touch signal includes one bit and the identification information is 3-bit, when only the first sense signal generator 400-1 is touched, the size of data transmitting from the first touch sense signal generator 400-1 to the host computer 420 is (3+log₂N). In this case, when all touch sense signal generators 400-1 to 400-N are touched, the size of data transmitting from the first touch sense signal generator 400-1 to the host computer 420 is N(3+log₂N). And when the N-th touch sense signal generator 400-N is touched and the others are not touched, the size of data transmitting from the first touch sense signal generator 400-1 to the host computer 420 is (3+log₂N).

According to the method described with reference to FIG. 4, the respective semiconductor devices 400-1 to 400-N store automatically generated ID information and only the ID information and touch information of a semiconductor device which actually generates a touch signal is transmitted to the host computer 420, so that the semiconductor devices 400-1 to 400-N can communicate with the host computer using a minimum size of data.

FIG. 5 is a diagram showing an identification information protocol for the communication of data between semiconductor devices according to an exemplary embodiment of the present invention.

FIG. 5 illustrates an ID information protocol 510 of each of the semiconductor devices 400-1 to 400-N of FIG. 4, which includes ID information generated and stored by each of the semiconductor devices 400-1 to 400-N and is used to communicate with an adjacent semiconductor device.

The ID information protocol 510 includes one start bit indicating the start of the ID information, one end bit indicating the end of the ID information, and an ID information bit for discriminating one semiconductor device from other semiconductor devices. When the semiconductor device outputs ID information generated after a supply voltage is initially applied, to an adjacent semiconductor device, the output information generator 240 of FIG. 2 includes the start bit, the end bit, and the generated ID information in the ID information protocol 510 and sends the resultant ID information protocol 510 to the I/O transceiver 250. When the adjacent semiconductor device receives the ID information protocol 510, the input information analyzer 230 analyzes the ID information protocol 510, extracts the ID information, and outputs the ID information to the controller 220. The controller 220 determines whether or not the ID information matches the stored ID information. In FIG. 5, when the semiconductor device includes a single touch pad, an object is determined as being brought into contact with the touch pad based only on the fact that the ID information protocol 510 includes the ID information bit. Although it is assumed that each of the start and end bits is a 1 bit for brevity, each of the start and end bits can be plural-bit data.

FIG. 6 is a diagram showing an apparatus control information protocol for the communication of data between semiconductor devices according to an exemplary embodiment of the present invention.

FIG. 6 illustrates an apparatus control information protocol 520, which is used to read and write control information stored in each of the semiconductor devices 400-1 to 400-N of FIG. 4 and to communicate with an external semiconductor device. The control information is stored in each of the semiconductor devices 400-1 to 400-N and may include data for controlling, for example, the sensitivity of a touch pad (not shown).

The apparatus control information protocol 520 includes one start bit indicating the start of the ID information, one end bit indicating the end of the ID information, and a predetermined amount of apparatus control information, which depends on the type of control information. Also, since the host computer 420 (refer to FIG. 4) stores the ID information of all the semiconductor devices 400-1 to 400-N in the controller 220, the apparatus control information protocol 520 further includes a predetermined bit of an ID information bit required for employing the ID information of one of the semiconductor devices 400-1 to 400-N to be controlled.

Thus, the respective touch pads connected to the semiconductor devices 400-1 to 400-N have different unique capacitances from the time of fabrication. The capacitance is checked by a predetermined test process in the fabrication, and the capacitance data is separately stored in the controller 220 and controlled to a predetermined sensitivity stored in the apparatus control information included in the apparatus control information protocol. This process will be described in more detail later with reference to FIG. 8.

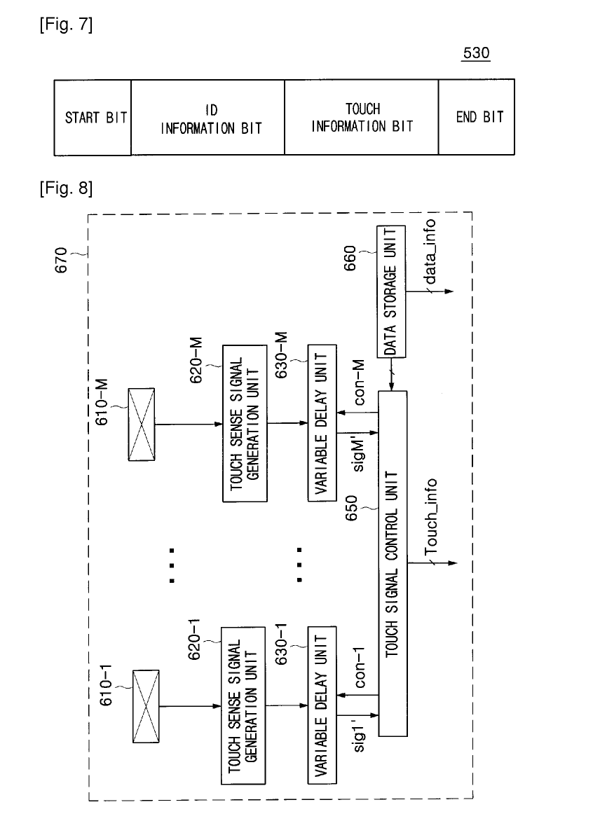

FIG. 7 is a diagram showing a touch information protocol for the communication of data between semiconductor devices according to an exemplary embodiment of the present invention.

Referring to FIG. 7, a touch information protocol 530 of each of the semiconductor devices 400-1 to 400-N includes one start bit indicating the start of the touch information, one end bit indicating the end of the touch information, an ID information bit which depends on the number of touch pads included in a sense signal generator, and a predetermined bit of touch information bit which stores a touch signal generated by the touch pad.

For example, when a touch sensor system includes 8 semiconductor devices and each of the semiconductor devices includes a single touch pad, a 3-bit ID information bit is required to discriminate one of the 8 semiconductor devices from other semiconductor devices.

Also, a predetermined bit of a touch information bit is set by one touch pad. For example, when a 3-bit touch information bit is set and the start and end bits are included, the data size of the touch information protocol 530 of FIG. 7 totals 1 byte.

FIG. 8 is a diagram showing a method of controlling the sensitivity of a touch pad of a semiconductor device according to an exemplary embodiment of the present invention.

In FIG. 8, reference character data_info denotes information on the sensitivity of a touch pad, con-1˜conM denotes a delay control signal, sig 1′˜sigM′ denotes a touch sense signal of the touch pad, and touch_info denotes at least one touch sense signals.

Part 670 of a semiconductor device corresponds to part of the controller 220 shown in FIG. 2. One or more touch pads 610 to 610-M included in the controller 220 output the corresponding touch signal via one or more touch sense signal generation units 620-1 to 620-M to one or more variable delay units 630-1 to 630-M in response to a touch.

A touch signal control unit 650 refers to data data_info stored in a data storage unit 660, and outputs control signals con-1 to con-M with reference to the sensitivity of the touch pads 610-1 to 610-M. The variable delay units 630-1 to 630-M control the delayed extent of a reference signal according to the sensitivities of the respective touch pads 610-1 to 610-M with reference to the control signals con-1 to con-M and generate and output touch sense signals sig1′ to sigM′. The touch signal control unit 650 receives the touch sense signals sig1′ to sigM′ and generates and outputs at least one touch sense signal touch_info.

As described above, data including the apparatus control information protocol 520 of FIG. 6 output by the host computer 420 of FIG. 4 is applied to the corresponding one of the semiconductor devices 400-1 to 400-N of FIG. 4 with reference to an internal ID information bit of the corresponding semiconductor device. The input information analyzer 230 of FIG. 2 analyzes the corresponding data and determines the sensitivity of a touch pad when the ID information bit is equal to internally stored ID information.

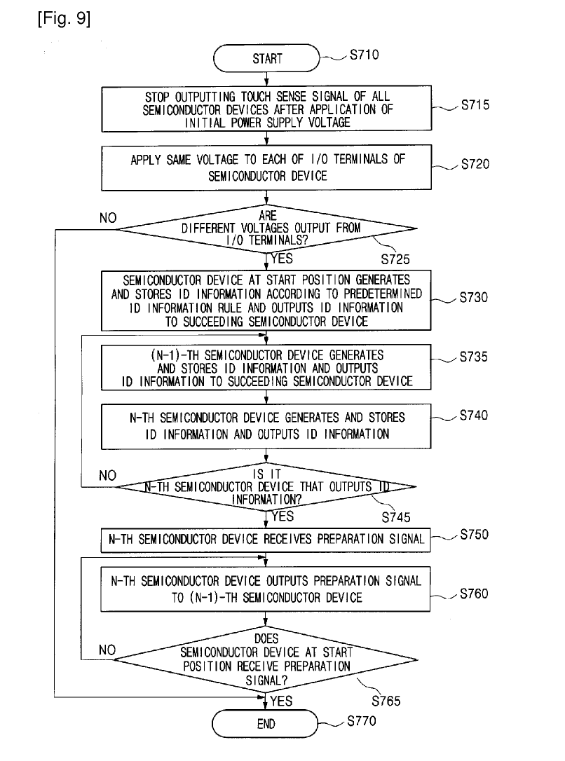

FIG. 9 is a flowchart showing a method of providing ID information of a semiconductor device according to an exemplary embodiment of the present invention. The method shown in FIG. 9 will now be described with reference to the construction and communication method of the semiconductor devices 400-1 to 400-N shown in FIGS. 2 through 4.

In step S715, after a supply voltage is initially applied to the semiconductor devices 400-1 to 400-N of FIG. 4, the switch 260 is turned off and each of I/O terminals 1-2′ to N-2′ and 1-3′ to N-3′ of FIG. 4 is not connected so that a touch sense signal generated in a state of contact of a touch pad with an external object is not generated.

Thereafter, in step S720, a high-level voltage is applied to each of the two I/O terminals 1-2′ to N-2′ and 1-3′ to N-3′ included in the semiconductor devices 400-1 to 400-N in order to confirm whether or not each of the I/O terminals 1-2′ to N-2′ and 1-3′ to N-3′ is connected to a ground voltage.

In step S725, when different voltages are output from the two I/O terminals, the corresponding semiconductor device is recognized as being at a start position. Specifically, due to the fact that the I/O terminal 1-2′ of the semiconductor device 400-1 is connected to the ground voltage, the semiconductor device 400-1 can be recognized as being at a start position.

In step S730, the controller 220 of the semiconductor device 400-1 at a start position generates and stores ID information according to a predetermined ID information generation rule. Thereafter, the switch 260 is turned on and the controller 220 outputs the corresponding ID information to the I/O transceiver 250. The I/O transceiver 250 receives the ID information and outputs the ID information to an adjacent semiconductor device 400-2 at least one times. Subsequently, the controller 220 switches the semiconductor device 400-1 to a stand-by state so that the semiconductor device 400-1 waits for a preparation signal output from the succeeding semiconductor device 400-2.

The controller 220 of the semiconductor device 400-2 adjacent to the semiconductor device 400-1 at a start position generates and stores ID information according to the preset ID information generation rule with reference to the ID information received from the I/O transceiver 250. Thereafter, the controller 220 of the semiconductor device 400-2 combines the received ID information with the generated ID information and outputs the combined ID information to an adjacent succeeding semiconductor device 400-3.

In steps S735 and S740, an N number of semiconductor devices 400-1 to 400-N repeat the same operation as described above. In this case, it is confirmed in step S745 whether or not it is an N-th semiconductor device 400-N that outputs the corresponding ID information. In step 750, the N-th semiconductor device receives an externally received preparation signal. Thereafter, in step S760, the N-th semiconductor device outputs the preparation signal to an (N−1)-th semiconductor device (not shown). This operation is repeated until the semiconductor device 400-1 at a start position receives the preparation signal in step S765. In this process, the respective semiconductor devices 400-1 to 400-N generate and store ID information and transmit the ID information to the host computer 420 of FIG. 2, which is an external control system.

A sensor device according to the present invention includes a plurality of serially connected semiconductor devices, each of which automatically generates ID information and transmits the ID information to a host computer. In this case, only the ID information and a touch sense signal of the semiconductor device that is in contact with an external object are transmitted to the host computer. Therefore, since the semiconductor device transmits no data in a state of non-contact with the object, the data size required for the communication of data between the semiconductor devices can be reduced when compared with a communication method of a conventional touch sense signal generator. Although only a touch sensor is described for brevity, the sensor device according to the present invention can be applied to other typical sensors, such as a pressure sensor and a proximity sensor.

Exemplary embodiments of the present invention have been disclosed herein and, although specific terms are employed, they are used and are to be interpreted in a generic and descriptive sense only and not for purposes of limitation. Accordingly, it will be understood by those of ordinary skill in the art that various changes in form and details may be made without departing from the spirit and scope of the present invention as set forth in the following claims.

1. A sensor device comprising a plurality of semiconductor devices connected in series, wherein:
when a semiconductor device does not sense a state of contact with an object and receives a first sensing data from a preceding semiconductor device, the semiconductor device outputs the first sensing data to a succeeding semiconductor device,
when the semiconductor device senses the state of contact with the object and receives the first sensing data from the preceding semiconductor device, the semiconductor device generates a second sensing data and outputs the first and second sensing data to the succeeding semiconductor device, and
when the semiconductor device senses the state of contact with the object and does not receive the first sensing data from the preceding semiconductor device, the semiconductor device generates the second sensing data and outputs the second sensing data to the succeeding semiconductor device.

2. The sensor device according to claim 1, which senses a touch applied to the semiconductor device.

3. The sensor device according to claim 1, which senses a pressure applied to the semiconductor device.

4. The sensor device according to claim 1, wherein the semiconductor devices are connected in a daisy-chain manner.

5. The sensor device according to claim 1, wherein after a supply voltage is initially applied to the semiconductor device, the semiconductor device generates and stores identification (ID) information and outputs the ID information to the succeeding semiconductor device.

6. The sensor device according to claim 5, wherein the semiconductor device outputs internally stored data to the succeeding semiconductor device in response to a control signal output from the preceding semiconductor device.

7. The sensor device according to claim 1, wherein the first sensing data or the second sensing data is a sensing information protocol including a sense signal.

8. The sensor device according to claim 7, wherein the sensing information protocol comprises:
a start bit indicating the start of the sensing information protocol;
the ID information;
the sense signal of at least one bit; and
an end bit indicating the end of the sensing information protocol.

9. The sensor device according to claim 6, wherein the internally stored data comprises:
a start bit indicating a start of a third data;
the ID information; and
an end bit indicating an end of the third data.

10. The sensor device according to claim 6, wherein the internally stored data comprises:
a start bit indicating a start of the third data;
the ID information;
at least 1-bit apparatus control information; and
an end bit indicating an end of the third data.

11. The sensor device according to claim 10, wherein the apparatus control information comprises information on the sensitivity of a touch pad comprised in the semiconductor device.

12. The sensor device according to claim 6, wherein the semiconductor device comprises:
at least one input/output (I/O) terminal;
at least one touch pad;
an I/O controller for enabling the semiconductor device to communicate with an adjacent semiconductor device;
a controller for controlling the I/O controller in response to a touch; and
a switch for turning on/off the I/O controller.

13. The sensor device according to claim 12, wherein the controller comprises:
a reference signal generation unit for generating a clock signal as a reference signal;
a first signal generation unit for receiving the reference signal and always delaying the reference signal by a first time irrespective of a state of contact of the semiconductor device with the object to generate a first signal;
a second signal generation unit for receiving the reference signal, the second signal generation unit not delaying the reference signal when the semiconductor device does not sense the state of contact with the object, and delaying the reference signal by a second time longer than the first time to generate a second signal when the semiconductor device senses the state of contact with the object; and
a sense signal generation unit for sampling and latching the second signal in synchronization with the first signal to generate a sense signal.

14. The sensor device according to claim 12, wherein the I/O controller comprises:
an I/O transceiving unit for communicating with the semiconductor device;
an input information analysis unit for analyzing the first sensing data and the third data applied to the I/O transceiving unit to output the analyzed data to the controller; and
an output information generation unit for generating the second sensing data in response to data output from the controller and outputting the second sensing data to the I/O transceiving unit.

15. A method of operating a sensor device, the method comprising the steps of:
generating, by at least one semiconductor device for generating a sense signal, identification (ID) information, storing and outputting the ID information to the succeeding semiconductor device after a supply voltage is initially applied to the semiconductor device;
outputting a first sensing data to the succeeding semiconductor device when a state of contact with an object is not sensed and the first sensing data is received from a preceding semiconductor device;
generating a second sensing data when the state of contact with the object is sensed, and outputting the first sensing data and the second sensing data to the succeeding semiconductor device when the first sensing data is received from the preceding semiconductor device; and
generating the second sensing data when the state of contact with the object is sensed and outputting the second sensing data to the succeeding semiconductor device when the first sensing data is not received from the preceding semiconductor device.

16. The method according to claim 15, wherein a touch applied to the semiconductor device is sensed and processed.

17. The method according to claim 15, wherein a pressure applied to the semiconductor device is sensed and processed.

18. The method according to claim 15, wherein the step of generating, by at least one semiconductor device for generating a sense signal, the identification (ID) information comprises the steps of:
stopping the output of the sense signal after a supply voltage is initially applied to the semiconductor device;
applying a predetermined voltage to the semiconductor device and comparing the predetermined voltage with an actually applied voltage to recognize a different semiconductor device as the semiconductor device at a start position;
outputting the ID information generated by the semiconductor device at the start position to the succeeding semiconductor device; and
outputting, by an N-th semiconductor device, only the ID information generated by the N-th semiconductor device when the ID information is received from an (N−1)-th semiconductor device, where N is a natural number.

19. The method according to claim 18, wherein the step of outputting the ID information comprises the step of combining the generated ID information with the ID information generated by at least one preceding semiconductor device and outputting the resultant ID information to the succeeding semiconductor device after a supply power is initially applied to the semiconductor device.

20. The method according to claim 15, further comprising the steps of:
outputting a preparation signal from the preceding semiconductor device to the succeeding semiconductor device; and
generating, by the at least one semiconductor device, the sense signal in response to the preparation signal when the state of contact with the object is sensed.

21. The method according to claim 15, further comprising the step of outputting, by the semiconductor device, internally stored data in response to a control signal from the preceding semiconductor device.

22. The method according to claim 21, wherein the internally stored data comprises information on the sensitivity of the semiconductor device.
